(19) United States
(12) Patent Application Publication
(10) Pub. No.: US 2008/0030236 A1
(43) Pub. Date: Feb. 7, 2008

(54) Multitask Circuit Comprising Resonant Element For Supplying Address And Data

(76) Inventor: Laszlo Csanyi, Budapest (HU)

Correspondence Address: JEROME D. JACKSON (JACKSON PATENT LAW OFFICE), 211 N. UNION STREET, SUITE 100, ALEXANDRIA, VA, 22314, US

(21) Appl. No.: 11/577,502

(22) PCT Filed: Oct. 20, 2005
(86) PCT No.: PCT/HU05/00117

§ 371 Date: Apr. 19, 2007

(30) Foreign Application Priority Data
Oct. 20, 2004 (HU) P0402132

(51) Int. Cl. H03K 5/125

(52) U.S. Cl. 327/44

(57) ABSTRACT

Multitask circuit (R) comprising resonant element for supplying address and data for address and value registering inputs of digital and analogue devices from a frequency specific source in which a resonator block (1) comprising at least one resonant element, a rectifier block (2), a capacitor block (3), an amplifier (F), signal comparators (4,6), a signal summing block (5), a signal sample storage (J), an integrator triggered on edge or level (7) and a comparator (8). An input (HF) of the multitask circuit (R) connected to a signal source (S) is connected to an input (I1) of a resonator block (1); an output (O1) of the resonator block (1) is connected to a first output (KI1) of the multitask circuit (R) either directly or through a rectifier block (2) comprising at least one diode and/or through a series connected amplifier (F). A serial capacitor block (3) is connected to a common point; the first output (KI1) of the multitask circuit (R) is connected to an analogue or digital input (TIN) of a storage cell (T).

The present invention relates to a multitask circuit comprising resonant element for supplying address and data information for address and value registering inputs of digital and analogue devices from a signal source. The multitask circuit has a resonator block comprising at least one resonant element, a rectifier block, a capacitor block, an amplifier, signal comparator blocks, a signal summing block, a signal sample storage block, an integrator triggered on edge or level, and a comparator.

In operation of electronic devices which need computer technology it is essential that the task should be processed and executed in a logical order. While for the customary digital processing of tasks an alternative exists (neural network), the electronic signal transmission is based on digital transfer of information which is based on the distinction of levels of a logical ‘1’ and a logical ‘0’.

Since digital transfer of information uses low energy levels, signal levels may be distorted due to external environmental effects, involving loss of information. Accordingly, safe transfer of signals is much more expensive than the technique used for producing the signal. Generally, errors derive from signal receiving circuits which store incorrect values and accordingly, the conclusions drawn from them will also be erroneous. Techniques used for error correction are also expensive. The present invention described in the preamble breaks with the digital conventions as it considers frequency as the basis of signal transmission and uses resonant elements for recognition of signals which is novel in comparison of the prior art. Typically, resonators are used for generating oscillation and not for recognition or decoding of addresses.

A first object of the present invention is to produce an improved communications circuit which is immune against noise and in which reception and decoding of an instruction and at the same time creation of the connection is performed by means of a single physical element, e.g. quartz crystal. Several parallel connected physical elements of this kind may be used simultaneously or a given point of these elements can be considered as a common point.

A second object of the present invention is to make transfer of several independent information possible—if required—in a given instruction time e.g. analogue value.

A third object of the present invention beside the frequency-based communication is to make transfer of information possible wherein the code and/or the system of numbers of the information is optional.

A fourth object of the present invention is to provide a low-cost circuit.

The invention is based on the realization of several details associated with each other. These are the following:

Firstly, it has been realized that if frequency is associated with information or instruction then a resonator placed in the information path operates as a switch. Due to the resonance, resistance between the input and the output decreases by orders. Consequently, current flows through the resonator which current generates controlling AND/OR switch signals on the outputs of the resonator connected to the digital or analogue inputs.

Secondly, it has been realized that the energy storing feature of the resonator can be utilized when the shape of the signal of excitation/input signal is changed and the shapes of the output signal and the input signal of the resonator placed in the information path are compared. The result of the comparison is IDENTICAL/DIFFERENT, that is, it represents a binary value of a logical ‘1’ or a logical ‘0’. If a numerical system is assigned to the shape of the signal then communication may be accomplished according to innumerable numerical systems due to the infinite number of signal shapes.

Thirdly, it has been realized that when coupling is based on the “insensible” feature of the shape of the input signal of the resonators then the width of the signal of the transmitter (PWM) can be modified at the receiver's side on an instruction issued at the transmitter's side. At the receiver's side a measurable analogue value can be assigned to the width of the signal, in this way the value (which can be DC as well) measured at the time of the instruction/marking can be evaluated at the transmitter within the cycle time of issuing the instruction.

Fourthly, it has been realized that the circuit according to the invention makes detection of cycles with zero voltage possible these cycles are missing from the input signal shape, which is the simplest way of digital signal communication.

The invention is a combination according to the opening paragraph in which an input of the multitask circuit comprises at least one resonant element connected to a signal source is coupled to an input of a resonator block comprising at least one resonant element. An output of the resonator block is connected to a first output of the multitask circuit either directly or through a rectifier block comprising at least one diode and/or a series connected amplifier. A capacitor block comprising at least one capacitor is connected to a common point of the series connection. The first output of the multitask circuit is connected to an analogue or digital input of a storage cell comprising at least one digital and/or analogue storage element. The outputs of the multitask circuit is not part of any oscillator or feedback circuit.

The essence of the present invention lies in that a frequency-based communication can be performed by means of resonators and supplemental elements connected to them while a high-level noise control is provided.

The resonant elements may be of a so called tuning-fork type elements, and also the so called QCAN resonant elements may be used for this purpose.

A detailed description of the coupling arrangement according to the invention will now be given with reference to the accompanying drawing.

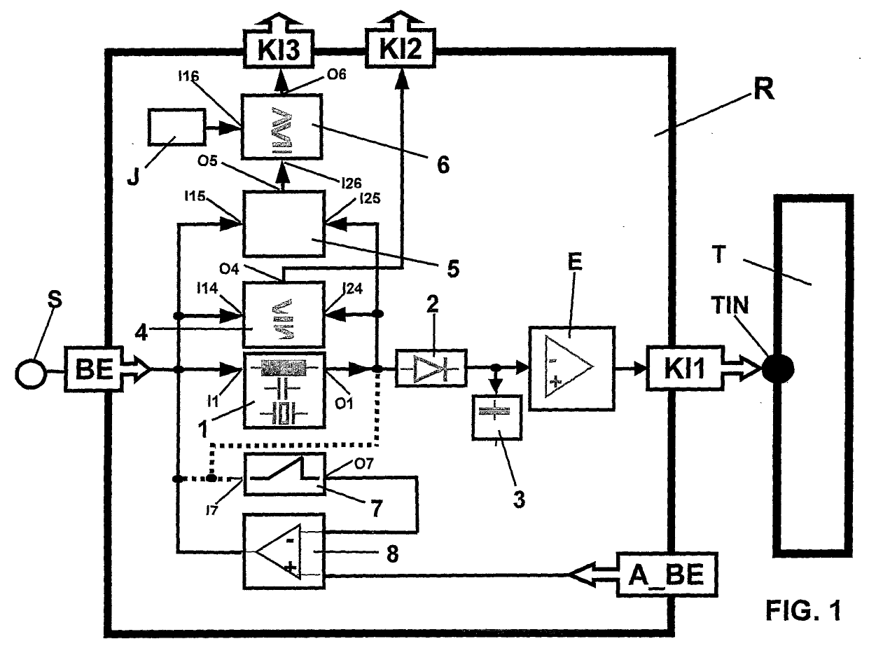

FIG. 1 shows the block scheme of a multitask circuit comprising resonant elements for supplying address and data for address and value registering inputs of digital and analogue devices from a frequency specific source.

In FIG. 1 the central element is a resonator block 1 comprising at least one resonant element, for e.g. a crystal.

On the one hand input BE of the multitask circuit R according to an embodiment of the invention is connected to signal source S, on the other hand it is connected to input I1 of resonator block 1 comprising at least one resonant element. Output O1 of the resonator block 1 comprising at least one resonant element and first output KI1 of the multitask circuit R are connected directly or through a rectifier block 2 comprising at least one diode, or through a series connected amplifier E. A capacitor block 3 comprising at least one capacitor is connected to a common point of the series connection. The first output KI1 of the multitask circuit R is connected to one input TIN of analogue or digital storage cell T comprising at least one digital and/or analogue storage element, excluding that any of the outputs of the multitask circuit R is a part of oscillator or feedback circuit.

At least one supplemental element is placed between input I1 and output O1 of resonator block 1 comprising at least one resonant element. It can be a first signal comparator block 4 whose first input I14 is connected to the input I1 of resonator block 1, its second input I24 is connected to output O1 of the resonator block 1 and its output O4 is connected to second output KI2 of the multitask circuit R, or it can be a signal summing block 5 whose first input I15 is connected to the input I1 of the resonator block 1, its second input I25 is connected to output O1 of resonator block 1, and its output O5 is connected to second input I26 of a second signal comparator block 6. At least one signal sample storage block J is connected to a first input I16, and output O6 is connected to third output KI3 of the multitask circuit R. Further, this supplemental element can be a comparator 8 and an integrator 7 triggered either on edge or level performing common functions. The phase reverser input of comparator 8 is connected to output O7 of the integrator 7. The phase non-reverser input of comparator 8 is connected to analogue input A_BE of the multitask circuit R. Further, input I7 of the integrator 7 may be connected either to input I1 or to output O1 of the resonator block 1, as indicated by dotted line in FIG. 1, but this connection can be omitted.

An exemplary embodiment of the invention will be further described hereinafter.

The resonator block 1 representing the central element in FIG. 1. One of the connecting points of input BE of the multitask circuit R is connected to signal source S. A signal can only be detected at output O1 of resonator block 1 if a predetermined frequency of a signal from signal source S corresponds to the resonance frequency of the resonator block 1. Then the signal at the output O1 of the resonator block 1 represents an identification of an instruction. If this signal is connected to the input TIN, the signal initializes the cell and performs registration at the signal registering input and deletion at the reset input. Rectifier block 2 besides its polarity dependent task performs peak-value rectifying together with capacitor block 3 and in this case an analogue value is produced by modifying the amplitude of the signal of signal source S. If a first signal comparator block 4 is placed between input I1 and output O1 of resonator block 1 comprising at least one resonant element then in steady-state condition congruence is detected at its output O4. If periodic input signal is kept on zero level for a periodic time, the first signal comparator block 4 will detect deviation. If logical zero is assigned to congruence and logical one is assigned to deviation, then information of a digital format with an optional code is produced by modulating the input signal which in the simplest case is available at the second output KI2 of the multitask circuit R. If the inputs of signal summing block 5 are connected in between input I1 and output O1 of resonator block 1, then the sum of the input signals can be seen at output O5 of the signal summing block 5. If the sum of signals is connected to second input I26 of the second signal comparator 6 and the signal provided by the signal sample storage block J is connected to input I16 of the second signal comparator 6, then a digital information dependent on the signal shape will appear at output O6 of the second signal comparator 6 and at the same time at the third output KI3 of the multitask circuit R comprising at least one resonant element. Since theoretically the number of the signal shapes is infinite, several independent outputs are applicable. If the integrator 7 is initiated through its starting input I7 by a signal available at input I1 or output O1 of resonator block 1 comprising at least one resonant element, a saw-tooth shaped signal will appear at output O7 which is connected to inverting input of comparator 8. At input A_BE of the multitask circuit R comprising at least one resonant element the non-inverting input of comparator 8 detects the DC signal to be measured. When a signal with varying voltage at the inverting input is beyond the level of the DC signal to be measured at the non-inverting input, a signal with a descending edge will appear at its output which forces the signal from signal source S at input BE of the multitask circuit R towards negative supply voltage and generates a pulse-width modulated signal which is proportionate to the voltage being present at the analogue input A_BE of the multitask circuit R.

From the foregoing it can be seen clearly that the solution according to the present invention contains a number of qualitative elements which compensate the relative slowness of signal transmission. The solution according to the invention eliminates the disadvantages of the conventional digital edge and signal level technique.

1. A multitask circuit comprising resonant element for supplying address and data information for address and value registering inputs of digital and analogue devices from a signal source, the multitask circuit having a resonator block comprising a resonant element, a rectifier block, a capacitor block, an amplifier, signal comparator blocks, a signal summing block, a signal sample storage block, an integrator triggered on edge or level, and a comparator, characterized in that an input of the multitask circuit connected to a signal source is coupled to an input of a resonator block comprising said resonant element; an output of the resonator block is connected to a first output of the multitask circuit either directly or through a rectifier block comprising a diode and/or a series connected amplifier; a capacitor block comprising a capacitor is connected to a common point of the series connection; said first output of said multitask circuit comprising a resonant element is connected to an analogue or digital input of a storage cell comprising a digital and/or analogue storage element; provided that the outputs of the multitask circuit is not part of any oscillator or feedback circuit.

2. Multitask circuit according to claim 1 characterized in that a supplemental element is placed between input and output of said resonator block; said supplemental element can be a first signal comparator block whose first input is connected to input of said resonator block, its second input is connected to output of said resonator block, its output is connected to second output of said multitask circuit; or it can be a signal summing block whose first input is connected to input of said resonator block, its second input is connected to output of said resonator block, its output is connected to second input of a second signal comparator block whose first input is connected to a signal sample storage block, its output is connected to third output of said multitask circuit; or it can be a comparator and an integrator triggered on edge or level performing common functions, wherein the phase reverser input of said comparator is connected to output of said integrator triggered on edge or level while the phase non-reverser input of said comparator is connected to analogue input of said multitask circuit, and input of said integrator triggered on edge or level is connected either to input or to output of said resonator block.

3. Multitask circuit according to claim 1, characterized in that the resonator elements include LC or piezo-crystal resonators.

4. Multitask circuit according to claim 1, characterized in that the resonator elements include tuning-fork type resonators.

5. Multitask circuit according to claim 2, characterized in that the resonator elements include LC or piezo-crystal resonators.

6. Multitask circuit according to claim 2, characterized in that the resonator elements include tuning-fork type resonators.

7. Multitask circuit according to claim 3, characterized in that the resonator elements include tuning-fork type resonators.
